(19) United States
(12) Patent Application Publication
(10) Pub. No.: US 2019/0130785 A1
(43) Pub. Date: May 2, 2019

(54) WEIGHT SCALE WITH FINANCIAL INCENTIVE OR DISINCENTIVE TO ASSIST USERS IN WEIGHT MANAGEMENT

(71) Applicant: Nikolaos Spanos, New York, NY (US)

(72) Inventor: Nikolaos Spanos, New York, NY (US)

(21) Appl. No.: 15/275,391

(22) Filed: Sep. 24, 2016

Related U.S. Application Data
(60) Provisional application No. 62/232,351, filed on Sep. 24, 2015.
(60) Provisional application No. 62/238,784, filed on Oct. 8, 2015.

(51) Int. Cl. G09B 19/00; G06Q 20/36; G06Q 20/06

(52) U.S. Cl. CPC G09B 19/0092; G06Q 20/065; G06Q 20/3678

(57) ABSTRACT

The present invention generally relates to weight scales. Specifically, embodiments of the present invention are directed to providing a weight management (e.g., loss, gain, maintenance) system consisting of an electronic scale device that measures body weight and reports measurements to a computing element embedded in the scale itself or via wireless technology to a companion application on a remote computing device (e.g., Smartphone, Tablet PC). Users set weight management goals, for instance, in pounds or kilos and length of time in which to manage weight on the application. Thereafter, weight management (e.g., loss, gain, maintenance) progress is tracked by the application every time the scale is used. As an incentive to complete weight management goals, users load money or digital currency into the application's built in fully-functional electronic wallet (software used to send/receive money or digital currency) (credit cards may also be accepted); if the user's weight management goals are not met, the money or electronic currency will be automatically sent to a third party of their choice. In certain embodiments, as a disincentive option, the system will send money to a third party is a person or group that the participant would not want to support or send money to. In certain embodiments, as an incentive option, the third party is a person or group that the participant would ordinarily want to send money to.

### CROSS-REFERENCE TO RELATED APLICATIONS

The present application claims priority from provisional application No. 62/232,351, filed Sep. 24, 2015 and provisional application No. 62/238,784 filed Oct. 8, 2015, the contents of which are incorporated by reference herein in their entirety.

### FIELD OF THE INVENTION

The present invention generally relates to weight scales. Specifically, embodiments of the present invention are directed to providing a weight management (e.g., loss, gain, maintenance) system consisting of an electronic scale device that measures body weight and reports measurements to a computing element embedded in the scale itself or via wireless technology to a companion application on a remote computing device (e.g., Smartphone, Tablet PC). Users set weight management goals, for instance, in pounds or kilos and length of time in which to manage weight on the application. Thereafter, weight management (e.g., loss, gain, maintenance) progress is tracked by the application every time the scale is used. As an incentive to complete weight management goals, users load money or digital currency into the application's built in fully-functional electronic wallet (software used to send/receive money or digital currency) (credit cards may also be accepted); if the user's weight management goals are not met, the money or electronic currency will be automatically sent to a third party of their choice. In certain embodiments, as a disincentive option, the system will send money to a third party is a person or group that the participant would not want to support or send money to. In certain embodiments, as an incentive option, the third party is a person or group that the participant would ordinarily want to send money to.

### BACKGROUND OF THE INVENTION

Weight loss and management has been a challenge for individuals throughout time. While multiple tools, programs, devices, drugs, supplements and other options exist for weight management, the probability for long term success still remains low. No matter how effective, individuals have a hard time sticking with such programs or continuing use of complex training equipment, expensive drugs, supplements or other regimens for targeting weight management.

Individuals generally fail long term at weight management due to lack of an ongoing incentive (or disincentive) to continue. Simply reverting back to old habits is just easier and more convenient for most.

However, there is one motivator that has consistently proven effective at motivating individuals long term, and that is finances. When an individual's money or other financial concerns come into play, many individuals will act more rigorously to protect those monetary and financial concerns.

Therefore, there is a need in the art for a system and method for providing financial incentive or disincentive to assist users in weight management. And there is a need in the art for a system and method for providing financial incentive or disincentive to assist users in weight management. These and other features and advantages of the present invention will be explained and will become obvious to one skilled in the art through the summary of the invention that follows.

### SUMMARY OF THE INVENTION

Accordingly, it is an object of the present invention to provide a system and method for providing financial incentive or disincentive to assist users in weight management.

According to an embodiment of the present invention, a system for providing financial incentive or disincentive to assist users in weight management comprises: a weight scale comprising a weighing surface, a weight detection and calculation means, a first processor, a first non-volatile computer readable memory and a first data communications means; wherein said weight detection and calculation means communicatively connected to said weighing surface such that a weight of one or more objects placed on said weighing surface is calculated; wherein said first processor is communicatively connected to said weight detection and calculation means, and wherein said first non-volatile computer-readable memory is configured with computer instructions configured to instruct said first processor to: receive a calculated weight reading from said weight detection and calculation means; transmit said calculated weight reading to a computing device; said computing device comprising a second processor, a second non-volatile computer readable memory and a second data communications means, wherein said second non-volatile computer-readable memory is configured with computer instructions configured to instruct said second processor to: receive said calculated weight reading; retrieve a first user profile associated said weight reading, wherein said first user profile comprises a weight goal; analyze difference between said weight goal and said calculated weight reading; and execute a currency transaction based on a delta between said difference between said weight goal and said calculated weight reading.

According to an embodiment of the present invention, said currency transaction deducts electronic currency from a digital wallet associated with said first user profile and transmits said electronic currency to a third party.

According to an embodiment of the present invention, a method for providing financial incentive or disincentive to assist users in weight management comprising the steps of: receiving a calculated weight reading from a weighted scale with a digital communications means; transmitting, from said weighted scale to a computing device, said calculated weight reading; receiving, at said computing device said calculated weight reading; retrieving a first user profile associated said weight reading, wherein said first user profile comprises a weight goal; analyzing difference between said weight goal and said calculated weight reading; and executing a currency transaction based on a delta between said difference between said weight goal and said calculated weight reading.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a diagram of a system for providing financial incentive or disincentive to assist users in weight management, in accordance with an embodiment of the present invention.

FIG. 2 is a flowchart showing a process for providing financial incentive or disincentive to assist users in weight management, in accordance with an embodiment of the present invention.

### DETAILED SPECIFICATION

The present invention generally relates to weight scales. Specifically, embodiments of the present invention are directed to providing a weight management (e.g., loss, gain, maintenance) system consisting of an electronic scale device that measures body weight and reports measurements to a computing element embedded in the scale itself or via wireless technology to a companion application on a remote computing device (e.g., Smartphone, Tablet PC). Users set weight management goals, for instance, in pounds or kilos and length of time in which to manage weight on the application.

According to an embodiment of the present invention, weight management (e.g., loss, gain, maintenance) progress is tracked by the application every time the scale is used. As an incentive to complete weight management goals, users load money or digital currency into the application's built in fully-functional electronic wallet (software used to send/receive money or digital currency) (credit cards may also be accepted); if the user's weight management goals are not met, the money or electronic currency will be automatically sent to a third party of their choice. In certain embodiments, as a disincentive option, the system will send money to a third party is a person or group that the participant would not want to support or send money to. In certain embodiments, as an incentive option, the third party is a person or group that the participant would ordinarily want to send money to.

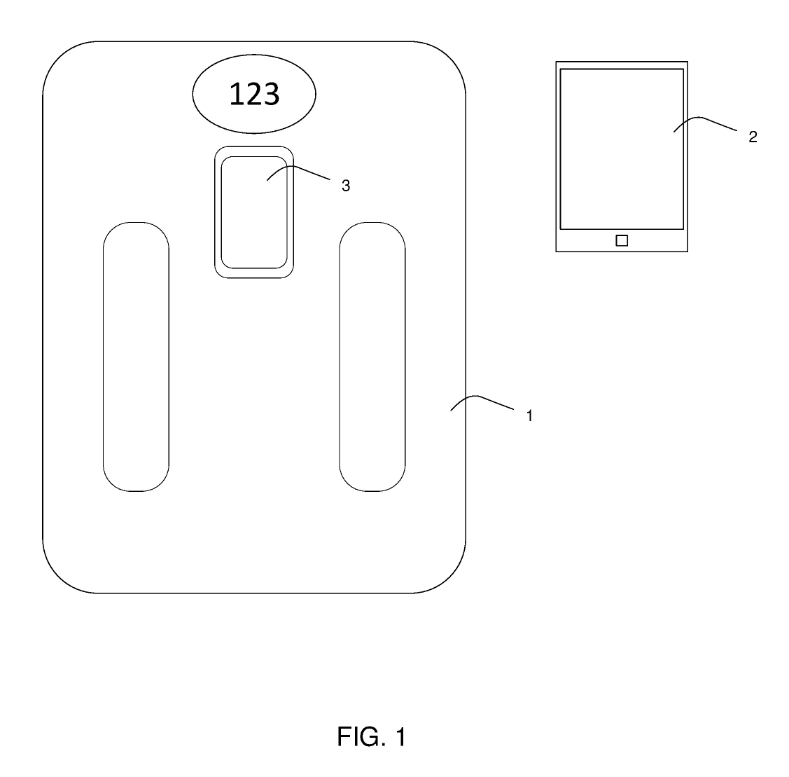

Turning now to FIG. 1, an exemplary embodiment of the present invention is shown. In this embodiment, a weight scale is shown with a surface for a user to stand on in order to have their weight determined by the weight scale. The surface could be made from any appropriate material, including, but not limited to, plastics, ceramics, tempered glass, metals or any combination thereof. One of ordinary skill in the art would appreciate that there are numerous materials that the surface could be made from, and embodiments of the present invention are contemplated for use with surfaces constructed of any appropriate materials.

According to an embodiment of the present invention, the weight scale further comprises a weight detection and calculation means and a computing means. The weight detection and calculation means. According to an embodiment of the present invention, components of the weight detection and calculation means may comprise, but are not limited to, spring scales, digital scales, pressure sensors, hydraulic or pneumatic scales, or any combination thereof. One of ordinary skill in the art would appreciate that there are numerous types of weight detection and calculation means that could be utilized with embodiments of the present invention, and embodiments of the present invention are contemplated for use with any appropriate weight detection and calculation means.

According to an embodiment of the present invention, the weight scale may further comprise one or more of a display element, a power source and a processing unit (i.e., computing means). The display element may be configured to display information associated with the scale, such as calculated weight of a user, settings and options of the scale (e.g., network connections, selectable options, scale settings, power level (e.g., battery level), or any combination thereof), or any combination thereof. In certain embodiments, the display element may be part of the processing unit and in other embodiments, the display element may be separate and distinct from the processing unit. In still further embodiments, more than one display element may be used, such as one display element specifically for displaying weight calculations, and a second display element present associated with the processing unit. In certain embodiments, the display element may also work as a human interface device (HID) and accept commands or other input from a user. For instance, the display element could be a capacitive touch screen or other interactive display.

According to an embodiment of the present invention, the processing unit comprises a processor, a memory and a communications means (such as circuitry for transmitting and receiving data via a communications protocol, such as BLUETOOTH or WIFI). In a preferred embodiment, the processing unit is configured to calculate, in conjunction with the weight detection and calculation means, a weight of a user, and transmit that weight calculation to a remote computing device via the communications means. The remote computing device could be, for instance, a Smartphone or other mobile computing device. In other embodiments, the remote computing device could be a third-party system, such as a server or distributed system remote from the weight scale and connected via a communications protocol.

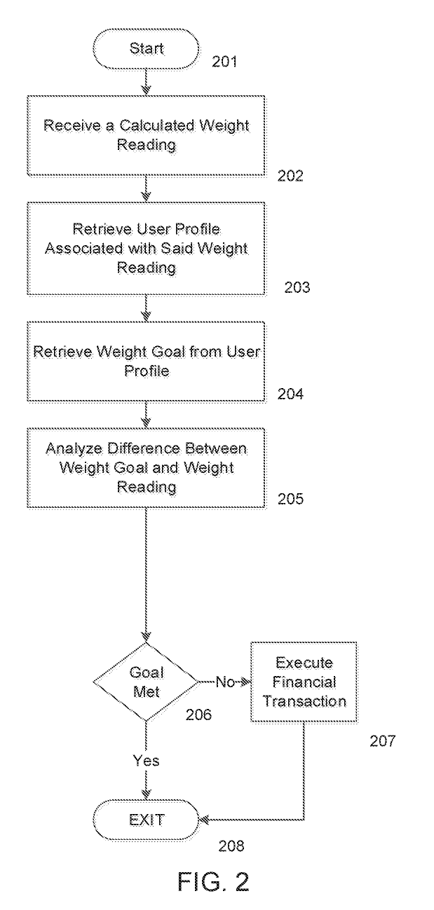

Turning now to FIG. 2, an exemplary method in accordance with an embodiment of the present invention is shown. In this method, the process starts at step 201 with a user stepping on the weight scale. At step 202, the system processes a calculated weight reading, which is a numerical representation of the weight/mass of the user.

At step 203, the system retrieves a user profile associated with the user who was weighed by the scale. The identity of the user may be provided, for instance, via selection of the identity of the user at the weight scale or otherwise identified on the remote computing device. Identification of the user could be done by any number of means, including biometrics, selection through input means on the weight scale or on the remote computing device, or any combination thereof. One of ordinary skill in the art would appreciate that there are numerous ways to identify the user and embodiments of the present invention are contemplated for use with any appropriate method for identifying the user.

At step 204, the system retrieves a weight goal associated with the user profile. In certain embodiments, this may be a target weight of the user (whether greater or lower than their current weight). Target weight could be not just an endpoint, but could include a target weight over time or over other identified period. For instance, a user may desire to lose 1 pound per week with a final weight 15 pounds down after the completion of 15 weeks. In this example, the target weight would be the weight as identified by the specific week in the process, not the final weight.

At step 205, the system analyzes the difference between the target weight and the weight reading. This is generally done by calculating the delta between the two weights. If the goal was met, the system could terminate the process (step 208). Otherwise, if the goal was not met, the system would execute a financial transaction that would ultimately constitute a disincentive to the user. This could be done, for instance, by subtracting an amount of a virtual or digital currency (e.g., crypto-currency, BITCOIN), from a digital wallet and transferring that amount to a third-party that would be a person or entity the user would not normally transfer money to (e.g., opposing political party committee). In alternative embodiments, the system could provide an incentive transaction for when the user meets the goals, such as by committing a financial transaction in favor of the user, either by way of depositing funds into a digital wallet of the user, or otherwise deducting currency from a digital wallet of a user, but in this case, transferring the amount to a third-party the user is favorable with. After completion of the financial transaction, the process would terminate.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of a special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. It is possible to modify or customize general-purpose systems to be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware specialized through computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing financial incentive or disincentive to assist users in weight management, said system comprising:
a weight scale comprising a weighing surface, a weight detection and calculation means, a first processor, a first non-volatile computer readable memory and a first data communications means;
wherein said weight detection and calculation means communicatively connected to said weighing surface such that a weight of one or more objects placed on said weighing surface is calculated;
wherein said first processor is communicatively connected to said weight detection and calculation means, and wherein said first non-volatile computer-readable memory is configured with computer instructions configured to instruct said first processor to:
receive a calculated weight reading from said weight detection and calculation means;
transmit said calculated weight reading to a computing device;
said computing device comprising a second processor, a second non-volatile computer readable memory and a second data communications means, wherein said second non-volatile computer-readable memory is configured with computer instructions configured to instruct said second processor to:
receive said calculated weight reading;
retrieve a first user profile associated said weight reading, wherein said first user profile comprises a weight goal;
analyze difference between said weight goal and said calculated weight reading; and
execute a currency transaction based on a delta between said difference between said weight goal and said calculated weight reading.

2. The system of claim 1, wherein said currency transaction deducts electronic currency from a digital wallet associated with said first user profile and transmits said electronic currency to a third party.

3. A method for providing financial incentive or disincentive to assist users in weight management, said method comprising the steps of:
receiving a calculated weight reading from a weighted scale with a digital communications means;
transmitting, from said weighted scale to a computing device, said calculated weight reading;
receiving, at said computing device said calculated weight reading;
retrieving a first user profile associated said weight reading, wherein said first user profile comprises a weight goal;
analyzing difference between said weight goal and said calculated weight reading; and
executing a currency transaction based on a delta between said difference between said weight goal and said calculated weight reading.

4. The method of claim 3, wherein said currency transaction deducts electronic currency from a digital wallet associated with said first user profile and transmits said electronic currency to a third party.
